(19) United States
(12) Patent Application Publication
(10) Pub. No.: US 2026/0360193 A1
(43) Pub. Date: Nov. 12, 2026

(54) DATA COLLECTION SYSTEM, IN-VEHICLE DEVICE, DATA COLLECTION METHOD, AND PROGRAM

(71) Applicant: DENSO CORPORATION, Kariya-shi (JP)

(72) Inventors: Mamoru HOSOKAWA, Kariya-shi (JP); Kensho Taki, Kariya-shi (JP); Shinichi Koike, Kariya-shi (JP)

(21) Appl. No.: 19/717,117

(22) Filed: Jun. 23, 2026

(30) Foreign Application Priority Data
Dec. 28, 2023 (JP) 2023-223266

(51) Int. Cl. G07C 5/00; B60K 35/10; B60K 35/28

(52) U.S. Cl. CPC G07C 5/008; B60K 35/10; B60K 35/28

(57) ABSTRACT

A data collection system acquires a determination data used for a trigger condition from a vehicle and determines whether or not the trigger condition is established by using the acquired determination data. The data collection system makes an inquiry to a driver of the vehicle upon determination that the trigger condition is established. The data collection system acquires a driver response data indicating a driver response to the inquiry from the vehicle and acquires one or more retrieval data items linked to the trigger condition from the vehicle.

### CROSS REFERENCE TO RELATED APPLICATION

This application is a continuation application of International Patent Application No. PCT/JP2024/045534 filed on Dec. 23, 2024, which designated the U.S. and claims the benefit of priority from Japanese Patent Application No. 2023-223266 filed on Dec. 28, 2023. The entire disclosures of all of the above applications are incorporated herein by reference.

### TECHNICAL FIELD

The present disclosure relates to a technology for collecting data from vehicles necessary for improving applications.

### BACKGROUND

There is a technology for distributing information indicating a collection condition and collection target data from a server to multiple vehicles and collecting data representing a status at a time of establishing the collection condition from each vehicle.

### SUMMARY

According to an aspect of the present disclosure, a data collection system may acquire a determination data used for a trigger condition from a vehicle and determine whether or not the trigger condition is established by using the acquired determination data. The data collection system may make an inquiry to a driver of the vehicle upon determination that the trigger condition is established. The data collection system may acquire a driver response data indicating a driver response to the inquiry from the vehicle and may acquire one or more retrieval data items linked to the trigger condition from the vehicle.

### BRIEF DESCRIPTION OF DRAWINGS

FIG. 1 is a block diagram showing a configuration of a data collection system.

FIG. 2 is a block diagram showing a configuration of an in-vehicle device.

FIG. 3 is a block diagram showing a configuration of a management center.

FIG. 4 is a functional block diagram showing a functional arrangement of a data collection system of a first embodiment.

FIG. 5 is an explanatory diagram showing an example of a trigger condition contained in trigger information.

FIG. 6 is an explanatory diagram showing an example of a retrieval data item list contained in the trigger information.

FIG. 7 is a sequence diagram showing basic operations between an in-vehicle device and an ECU/retrofit-device group.

FIG. 8 is a sequence diagram showing operations between the management center and the in-vehicle device in the first embodiment.

FIG. 9 is a flowchart of a dissatisfaction survey process of the first embodiment.

FIG. 10 is a functional block diagram showing a functional arrangement of a data collection system of a second embodiment.

FIG. 11 is a flowchart of a dissatisfaction survey process of the second embodiment.

FIG. 12 is a sequence diagram showing operations between the management center and the in-vehicle device in the second embodiment.

### DETAILED DESCRIPTION

There is a technology for distributing information indicating a collection condition and collection target data from a server to multiple vehicles and collecting data representing a status at a time of establishing the collection condition from each vehicle.

For efficient improvement of an application program implementing a vehicle functionality, it is conceivable to collect annotated data such as a data detected under a situation where the driver is feeling dissatisfied.

However, such an issue has been found that highly accurate detection of driver's dissatisfaction is impossible when information of a single vehicle operation or the like alone acquired via an in-vehicle network is a collection condition.

The present disclosure provides a technology for accurately collecting annotated data.

According to a first aspect of the present disclosure, a data collection system is provided that includes a distributor, a first acquirer, a first determiner, a second acquirer, an asker and a third acquirer.

The distributor is configured to perform distribution to one or more vehicles. Trigger information is information in which a trigger condition and one or more retrieval data items to be acquired upon establishment of the trigger condition are linked to each other. The trigger condition is defined by one or more individual conditions in combination that a determination data which is based on one or more data items acquired from the vehicle is to meet.

The first acquirer is configured to acquire, from a target vehicle, the determination data used for the trigger condition according to the trigger information, wherein the target vehicle is the vehicle to which the trigger information is distributed. The second acquirer is configured to, upon the first determiner determining that the trigger condition is established, acquire the one or more retrieval data items linked to the trigger condition in the trigger information from the target vehicle.

The asker is configured to, upon the first determiner determining that the trigger condition is established, make an inquiry to a driver of the target vehicle. The third acquirer is configured to acquire a driver response data indicating a driver response to the inquiry made by the asker from the target vehicle.

According to the above configuration, it is possible to accurately collect annotated data, i.e., data representing a situation where the driver feels dissatisfied.

According to a second aspect of the present disclosure, an in-vehicle device is provided that includes a trigger information storage, a first acquirer, a first determiner, an asker, a third acquirer, a second determiner, a second acquirer and a transmitter.

The trigger information storage stores trigger information. The first acquirer is configured to acquire, from a vehicle, a determination data used for a trigger condition according to the trigger information. The first determiner is configured to determine whether or not the trigger condition is established, by using the determination data acquired by the first acquirer. The asker is configured to, upon the first determiner determining that the trigger condition is established, make an inquiry to a driver of the vehicle. The third acquirer is configured to acquire a driver response data indicating a driver response to the inquiry made by the asker from the vehicle. The second determiner is configured to determine whether or not driver dissatisfaction is indicated in the driver response data acquired by the third acquirer. The second acquirer is configured to, upon the second determiner determining that the driver dissatisfaction is indicated in the driver response data, acquire the one or more retrieval data items linked to the trigger condition in the trigger information from the vehicle. The transmitter is configured to transmit the one or more retrieval data items acquired by the second acquirer to an external device that performs wireless communication with the in-vehicle device.

According to this configuration, by using the in-vehicle device as a component of the above data collection system, it is possible to provide the same effect as the above data collection system.

According to a third aspect of the present disclosure, an in-vehicle device is provided that includes a trigger storage, a first acquirer, a first determiner, and a second acquirer, an asker and a third acquirer.

The trigger information storage stores trigger information. The first acquirer is configured to acquire, from a vehicle, a determination data used for a trigger condition according to the trigger information. The first determiner is configured to determine whether or not the trigger condition is established, by using the determination data acquired by the first acquirer. The second acquirer is configured to, upon the first determiner determining that the trigger condition is established, acquire the one or more retrieval data items linked to the trigger condition in the trigger information from the vehicle. The asker is configured to, upon the first determiner determining that the trigger condition is established, make an inquiry to a driver of the vehicle. The third acquirer is configured to acquire a driver response data indicating a driver response to the inquiry made by the asker from the vehicle. The transmitter is configured to transmit the one or more retrieval data items acquired by the second acquirer and the driver response data acquired by the third acquirer to an external device that performs wireless communication with the in-vehicle device.

According to this configuration, by using the in-vehicle device as a component of the above data collection system, it is possible to provide the same effect as the above data collection system. Further, according to this configuration, an outside of the in-vehicle device performs a process as the second determiner in the above data collection system, reducing a processing burden of the in-vehicle device.

According to a fourth aspect of the present disclosure, a data collection method using a trigger information is provided. The data collection method includes: acquiring, from a target vehicle, a determination data used for a trigger condition according to trigger information, wherein the target vehicle is a vehicle to which the trigger information is distributed; and determining whether or not the trigger condition is established, by using the determination data. The data collection method includes: upon determining that the trigger condition is established, acquiring the one or more retrieval data items linked to the trigger condition in the trigger information from the vehicle. The data collection method includes: upon determining that the trigger condition is established, making an inquiry to a driver of the target vehicle; and acquiring a driver response data indicating a driver response to the inquiry from the target vehicle. The data collection method includes: determining whether or not driver dissatisfaction is indicated in the driver response data; and upon determining that the driver dissatisfaction is indicated in the driver response data, storing the one or more retrieval data items in a storage device as dissatisfaction survey data, thereby collecting the dissatisfaction survey data.

By using this method, it is possible to provide the same effect as the above data collection system.

According to a fifth aspect of the present disclosure, a program using a trigger information is provided. The program causes a computer mounted on a vehicle to function as a first acquirer, a first determiner, an asker, a third acquirer, a second determiner, a second acquirer, and a transmitter.

By executing this program, it is possible to provide the same effect as the above in-vehicle device including the first acquirer, the first determiner, the asker, the third acquirer, the second determiner, the second acquirer, and the transmitter.

According to a sixth aspect of the present disclosure, a program using a trigger information is provided. The program causes a computer mounted on a vehicle to function as a first acquirer, a first determiner, a second acquirer, an asker, a third acquirer, and a transmitter.

By executing this program, it is possible to provide the same effect as the above in-vehicle device including the first acquirer, the first determiner, the second acquirer, the asker, the third acquirer, and the transmitter.

According to a seventh aspect of the present disclosure, a management center is provided that includes a distributor, a second acquirer, and a third acquirer. The distributor is configured to distribute trigger information to one or more vehicles. The second acquirer is configured to acquire one or more retrieval data items linked to a trigger condition in the trigger information from a target vehicle upon a first determiner determining that the trigger condition is established. The third acquirer is configured to acquire a driver response data indicating a driver response to an inquiry made by an asker from the target vehicle.

According to this configuration, by using an external device of the data collection system, it is possible to provide the same effect as the data collection system.

According to an eighth aspect of the present disclosure, a data collection method is provided that includes: distributing trigger information to one or more vehicles; acquiring one or more retrieval data items linked to a trigger condition from a target vehicle upon determining that the trigger condition is established; and acquiring a driver response data indicating a driver response to an inquiry made by an asker from the target vehicle upon determining that the trigger condition is established, make the inquiry to the driver of the target vehicle.

By using this method, it is possible to provide the same effect as the data collection system.

According to a nineth aspect of the present disclosure, a program is provided that causes a computer of a management center to function as a distributor, a second acquirer and a third acquirer.

By executing this program, it is possible to provide the same effect as the data collection system.

Embodiments of the present disclosure will be described with reference to the drawings.

### 1. First Embodiment

### 1-1. Overall Configuration

A data collection system 1 of the present embodiment collects dissatisfaction survey data. The dissatisfaction survey data refers to annotated data usable for improvement of an application program implementing a vehicle functionality, such as a data representing a situation where a driver feels dissatisfied with the vehicle functionality.

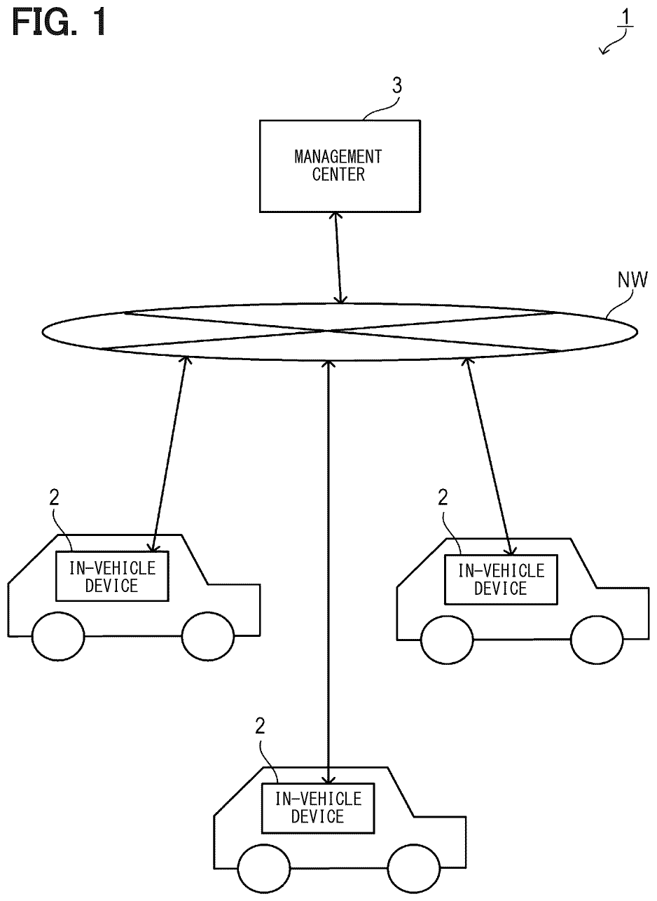

As shown in FIG. 1, the data collection system 1 includes multiple in-vehicle devices 2 and a management center 3.

The in-vehicle device 2 is mounted on the vehicle and has a function of performing data communication with the management center 3 via a wide-area wireless communication network NW.

The management center 3 has a function of performing data communication with the in-vehicle device 2 via the wide-area wireless communication network NW.

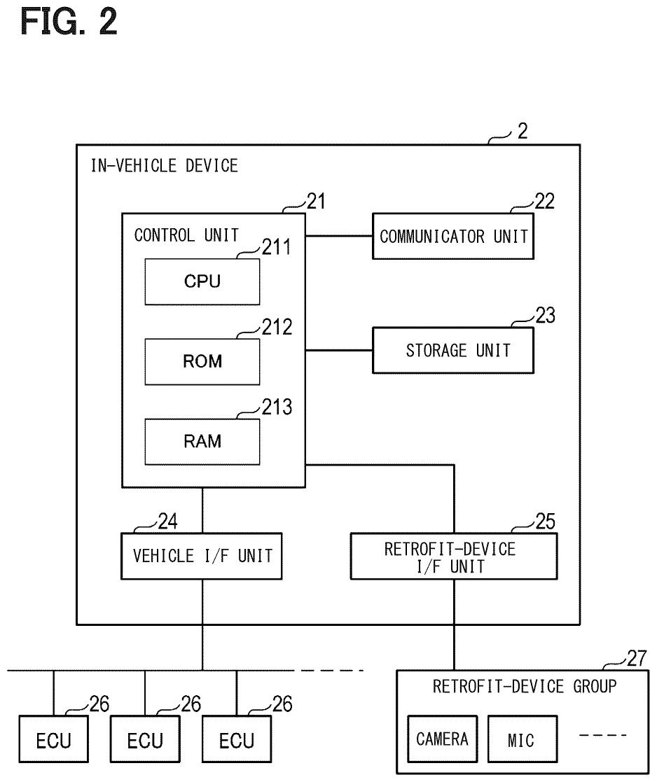

As shown in FIG. 2, the in-vehicle device 2 includes a control unit 21, a communication unit 22, a storage unit 23, a vehicle interface (hereinafter referred to as the vehicle I/F) unit 24, and a retrofit-device I/F unit 25.

The controller 21 is an electronic control unit including, as its main component, a microcomputer including a CPU 211, a ROM 212, a RAM 213, and the like. Various functions of the microcomputer are implemented by the CPU 211 executing programs stored in a non-transitory tangible storage medium. In this example, the ROM 212 corresponds to the non-transitory tangible storage medium storing the programs. Note that part or all of the functions executed by the CPU 211 may be implemented by configuring hardware with one or more ICs. The number of microcomputers in the control unit 21 may be one or more.

The communication unit 22 performs data communication with the management center 3 via the wide-area wireless communication network NW.

The storage unit 23 is a storage device for storing various data.

For data communication, the vehicle I/F unit 24 is connected to multiple ECUs 26 via a CAN bus installed in the vehicle. CAN is an abbreviation for Controller Area Network. The vehicle I/F unit 24 transmits and receives data according to the CAN communication protocol.

For data communication, the retrofit-device I/F unit 25 is connected to a retrofit—device group 27, which is retrofitted to the vehicle. The retrofit-devices may include a camera, a microphone, a speaker, a display, an accelerometer, and a gyroscope.

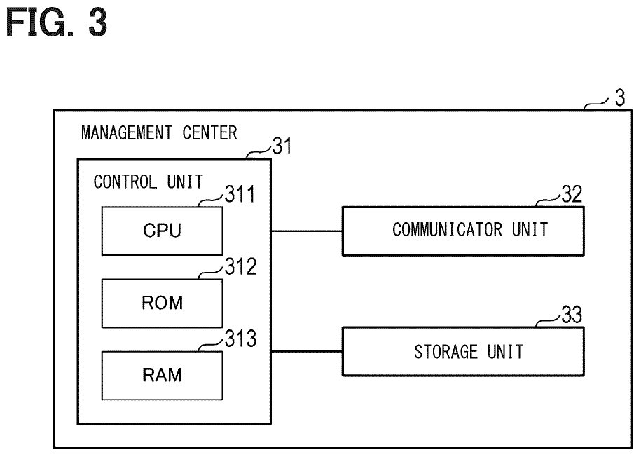

The management center 3 includes a control unit 31, a communication unit 32, and a storage unit 33, as shown in FIG. 3.

The controller 31 is an electronic control unit including, as its main component, a microcomputer including a CPU 311, a ROM 312, a RAM 313, and the like. Various functions of the microcomputer are implemented by the CPU 311 executing programs stored in a non-transitory tangible storage medium. In this example, the ROM 312 corresponds to the non-transitory tangible storage medium storing the programs. Note that part or all of the functions executed by the CPU 311 may be implemented by configuring hardware with one or more ICs. The number of microcomputers in the control unit 31 may be one or more.

The communication unit 32 performs data communication with multiple in-vehicle devices 2 via the wide-area wireless communication network NW.

The storage unit 33 is a storage device for storing various data.

### 1-2. Functional Configuration

Functional configuration of the data collection system 1 will be described below.

### 1-2-1. Management Center

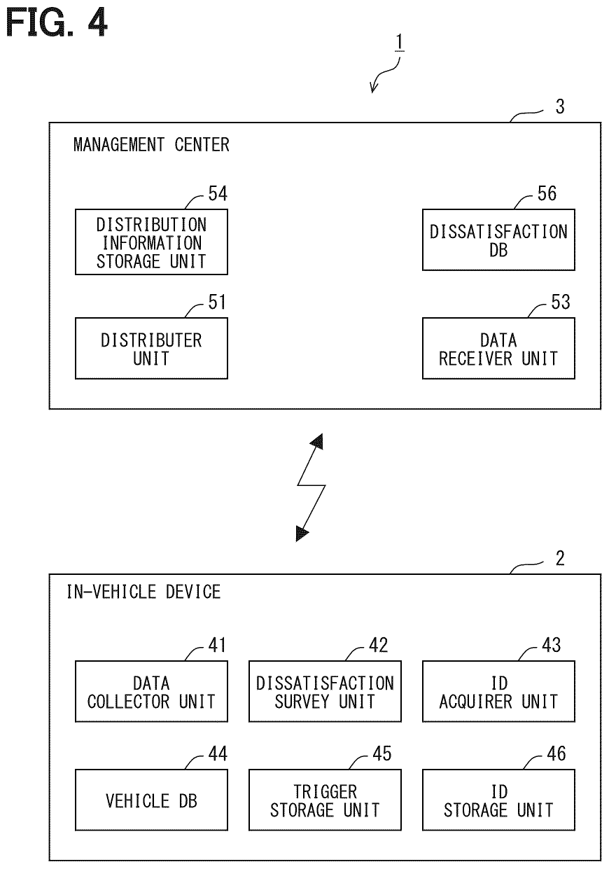

As shown in FIG. 4, the management center 3 includes a distributor unit 51 and a data receiver unit 53 as functional blocks implemented by the CPU 311 executing the program stored in the ROM 312. The storage unit 33 of the management center 3 includes a distribution information storage unit 54 and a dissatisfaction database (hereinafter referred to as dissatisfaction DB) 56.

The distribution information storage unit 54 stores one or more trigger records to be distributed to the vehicles. The trigger information record is information in which a trigger condition, inquiry information and a retrieval data item list are linked to each other. Each trigger information record is identified by its trigger ID.

The trigger condition is defined by one or more individual conditions in combination. The individual condition indicates a condition that a single piece of determination data is to meet. Individual values of various data acquired at the vehicle may be used as the determination data. A result of specific processing on various data acquired at the vehicle may be used as the determination data. The specific processing may include, for example, speech recognition processing, image recognition processing, statistical processing, etc. The speech recognition processing recognizes, for example, words uttered by the driver. The image recognition processing recognizes, for example, a driver's state (e.g., facial expression, behavior) The statistical processing may include an operation of removing outliers from large datasets, etc.

The inquiry information is information used in making an inquiry the driver about dissatisfaction presence and absence upon establishment of the trigger condition.

The retrieval data item list indicates one or more data items to be acquired as dissatisfaction survey data upon establishment of the trigger condition.

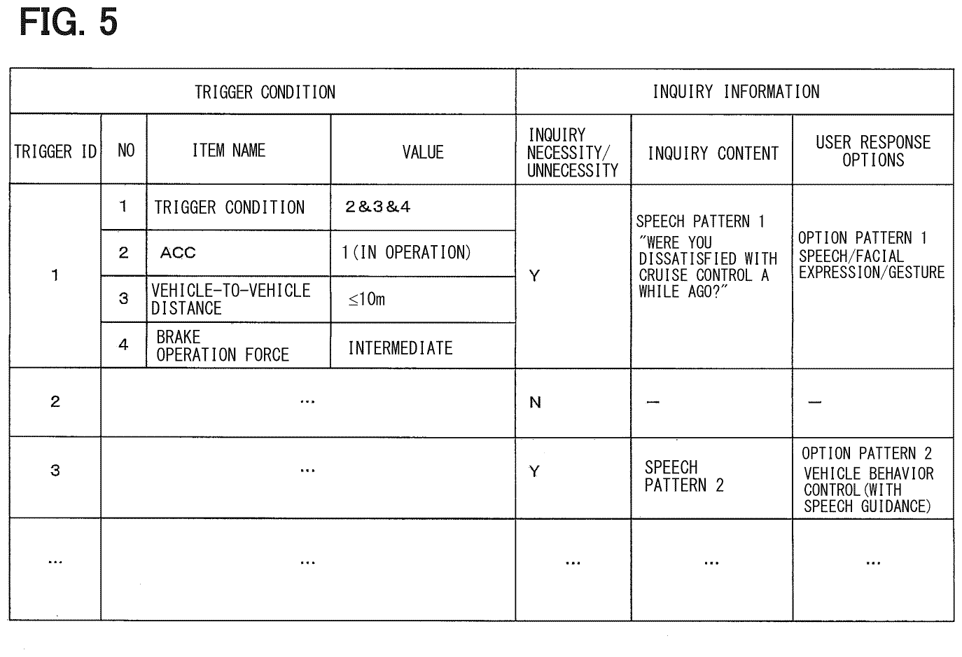

FIG. 5 shows an example of how the trigger condition and the inquiry information are defined.

The trigger condition is defined so that the trigger condition is linked to the trigger ID. The trigger condition includes individual conditions listed as shown in No. 2 to No. 4 in FIG. 5, along with a manner of combining these individual conditions as shown in No. 1 in FIG. 5. In this case, all the individual conditions are combined using logical AND. Alternatively, logical OR, negation, etc., may be included.

The individual condition specifies the determination data to be used, and values that the determination data is to meet. The determination data of the individual condition may include, for example, an ACC operation status, a vehicle-to-vehicle distance, a break operation force, etc. The condition may be met when the “ACC operation status” is, for example, in operation.” The condition may be met when the “vehicle-to-vehicle distance” is, for example, 10 meters or less. The condition may be met when the “break operation force” is an intermediate magnitude. The trigger condition using the above three individual conditions is used to detect a situation where the driver operates the brake during the operation of the ACC to forcibly stop the control and further a forward vehicle is present at a nearby position.

The inquiry information record is set for each trigger ID. The inquiry information may include “inquiry necessity/unnecessity,” “inquiry content,” and “driver response options.” The “inquiry necessity/unnecessity” indicates whether to make the inquiry to the driver upon establishment of the trigger condition identified by the trigger ID, by using Y (i.e., inquiry necessity) and N (i.e., inquiry unnecessity).

The “inquiry content” indicates a manner and content of the inquiry to be made to the driver. The manner of the inquiry may be using speech, screen display, vehicle behavior control, etc. In the case of using the speech, the “inquiry content” may indicate which of pre-prepared speech patterns is to be used or may directly indicate content to be conveyed via speech for an environment where synthesis speech cab be output. Specifically, if a forcible stop of the ACC is detected according to the trigger condition, the inquiry is made about “Ware you dissatisfied with the cruise control a moment ago?”.

The manner of the inquiry may be visually making the inquiry using the display screen in addition or in place of auditorily making the inquiry using the speech. in addition to or in place of making the inquiry using the speech and/or the screen display, the inquiry may be tactilely made using the vehicle behavior control. More specifically, making the inquiry using the vehicle behavior control may use a single operation such as an instantaneous acceleration/deceleration, an instantaneous steering operation, etc. When the inquiry using the vehicle behavior control is made in conjunction with the speech and the screen display, the driver may be aware of the inquiry even if the driver fails to notice the speech and the screen display. The “driver response option” indicates one or more manners of detecting the driver response. The options may include the speech of the driver, the facial expression of the driver, the gesture of the driver, and the vehicle operation of the driver. For example, it may indicate which of pre-prepared option patterns is to be used. Contents of the “driver response option” may be conveyed to the driver in the form of speech together with the inquiry to the driver. In the case of using the vehicle operation of the driver in particular, speech guidance may made to indicate a concrete vehicle operation which is something like “Please turn right the steering wheel if the answer is YES, please turn left the steering wheel if the answer is NO.”

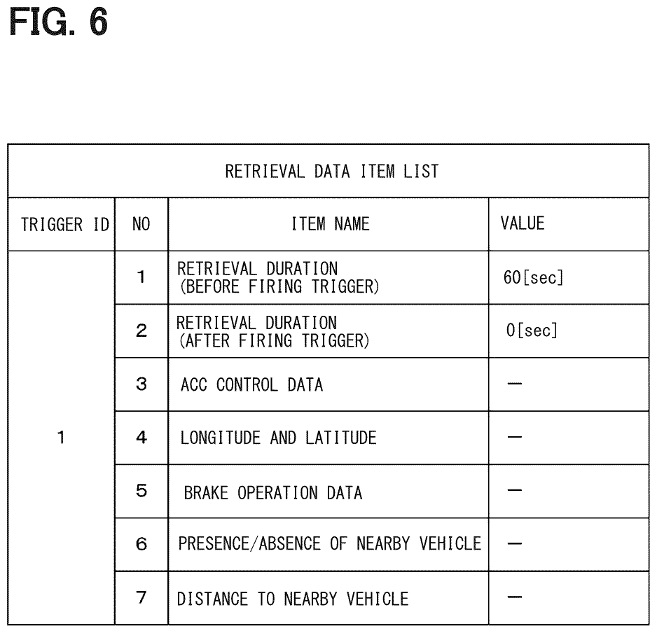

FIG. 6 shows an example of how the retrieval data item list is defined.

The retrieval data item list is defined so that the retrieval data item list is linked to the trigger ID. In other words, it is linked to the trigger condition via the trigger ID. Furthermore, a single trigger information record is formed with the trigger condition and the retrieval data item list linked to each other via the trigger ID. The retrieval data item list lists up the data items to be acquired, as shown in No. 3 to No. 7 in FIG. 6. Additionally, the retrieval data item list may indicate the data retrieval duration, as shown in No. 1 and No. 2 in FIG. 6. The retrieval duration may be specified as two separate durations: a duration before firing the trigger (firing the trigger is also called establishing the condition) and a duration after firing the trigger.

The retrieval data items may include an operational status of a control (e.g., ACC), the driver's driving operation status (e.g., accelerator pedal position), the vehicle position (e.g., latitude and longitude), and an environment around the vehicle (e.g., presence/absence of nearby vehicles, distance to nearby vehicles).

The description returns to FIG. 4. The dissatisfaction DB 56 stores the dissatisfaction survey data that the vehicles, to which the trigger information has been distributed, transmit based on the trigger information. The dissatisfaction survey data is a data indicated in the retrieval data item list.

When a given distribution condition is met, the distributor unit 51 distributes the trigger information stored in the distribution information storage unit 54 to each vehicle being a distribution target.

When the data receiver unit 53 receives the dissatisfaction survey data from the vehicle to which the trigger information has been distributed, the data receiver unit 53 stores the received dissatisfaction survey data in the dissatisfaction DB 56 while classifying it for each driver ID and each trigger ID.

### 1-2-2. In-vehicle Device

As shown in FIG. 4, the in-vehicle device 2 includes a data collector unit 41, a dissatisfaction survey unit 42, and an ID acquirer unit 43 as functional blocks implemented by the CPU 211 executing the program stored in the ROM 212. The storage unit 23 of the in-vehicle device 2 includes a vehicle database (hereinafter referred to as the vehicle DB) 44, a trigger storage unit 45, and an ID storage unit 46.

The vehicle DB 44 stores data collected by the data collector unit 41. The vehicle DB 44 stores the data for a given period or longer, which is set so as to over the whole of the retrieval duration indicated in the retrieval data item list.

The trigger storage unit 45 stores the trigger information distributed from the management center 3. Addition or update of the trigger information may be made as appropriate following a command from the management center 3.

The ID storage unit 46 stores the driver ID acquired by the ID acquirer unit 43. The driver ID is information for identifying the driver who is currently in the vehicle equipped with the in-vehicle device 2.

The data collector unit 41 collects various data provided by the ECU 26 and the retrofit-device group 27 in a chronological order via the vehicle I/F unit 24 and the retrofit-device I/F unit 25. The data collected via the vehicle I/F unit 24 may include behavior data representing vehicle behavior, operation data representing driver operation, status data representing the status of onboard equipment, and diagnostic data generated by each ECU 26. Hereinafter, the behavior data, the operation data, the status data, and the diagnostics data are collectively referred to as vehicle data.

The data collected via the retrofit-device I/F unit 25 may include driver speech data, image data capturing the driver's facial expression and his or her upper body movement, and biometric data representing the driver's body temperature, heart rate, and other such information. Hereinafter, the voice data, the image data, the biometric data, and other data related to the driver are collectively referred to as driver data.

Furthermore, the data collector unit 41 may acquire the driver data from devices originally installed in the vehicle via the vehicle interface unit 24. Additionally, the data collector unit 41 may acquire the vehicle data from the retrofit-device group 27, which is retrofitted to the vehicle, via the retrofit-device I/F unit 25.

The dissatisfaction survey unit 42 may be implemented, for example, by executing an application program distributed from the management center 3. As the dissatisfaction survey data, the dissatisfaction survey unit 42 transmits the vehicle data and the driver data acquired according to the trigger information stored in the trigger storage unit 45 to the management center 3. Details of processes in the dissatisfaction survey unit 42 will be described later.

At startup of the in-vehicle device 2, the ID acquirer unit 43 recognizes the driver who is currently in the vehicle equipped with the in-vehicle device 2, acquires the driver ID of the recognized driver, and stores it in the ID storage unit 46.

### 1-3. Operation

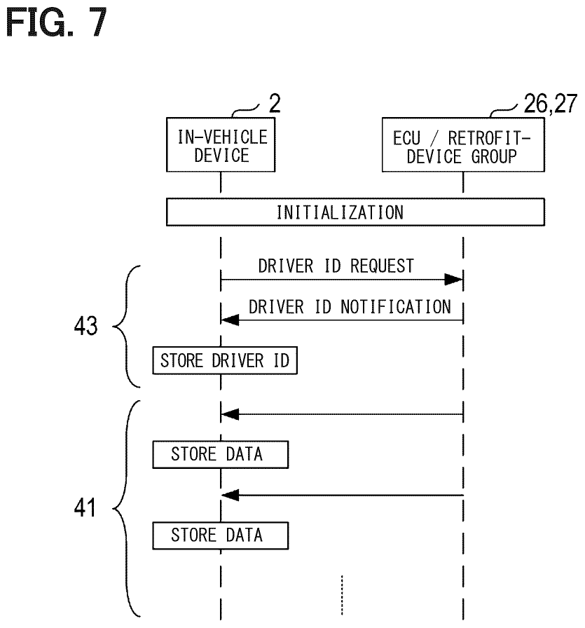

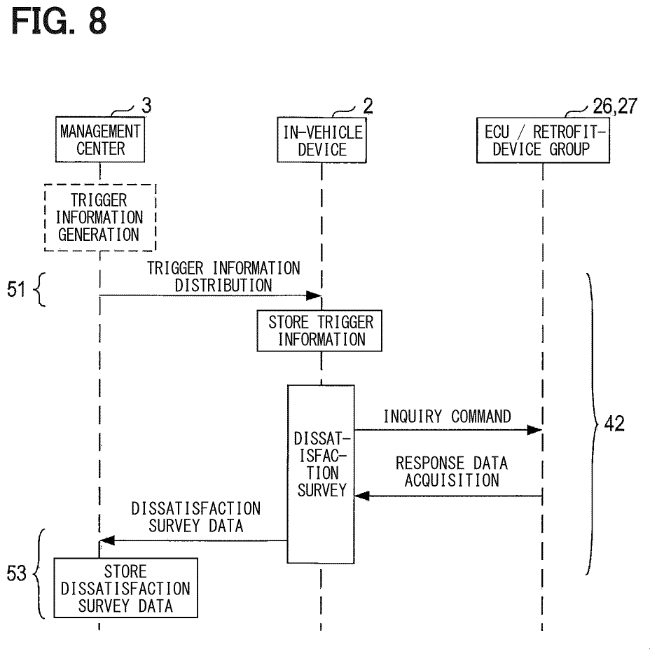

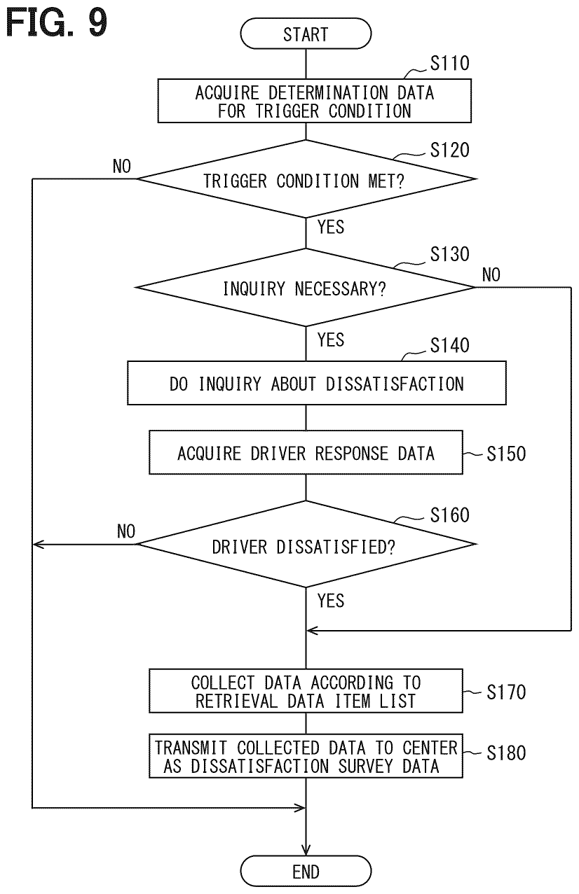

The operation of the data collection system 1 will be described using the sequence diagrams shown in FIG. 7 and FIG. 8, and the flowchart shown in FIG. 9.

As shown in FIG. 7, when the vehicle power is turned on, the in-vehicle device 2 and the ECU 26 become active and execute an initialization process. In response to being communicable with the ECU 26 via the in-vehicle I/F unit 24 and with the retrofit-device group 27 via the retrofit-device I/F unit 25 due to the initialization process, the control unit 21 of the in-vehicle device 2 executes a process as the ID acquirer unit 43. Specifically, the control unit 21 acquires the driver ID and stores the acquired driver ID in the ID storage unit 46. The driver ID may be acquired, for example, through an application programming interface (API) that provides various vehicle functions. Specifically, for example, the driver may be identified based on an image of the driver.

Subsequently, the control unit 21 executes a process as the data collector unit 41. Specifically, the control unit 21 monitors data flowing in the CAN bus, extracts the vehicle data that needs to be collected, and stores it in the vehicle database 44. Additionally, the control unit 21 may acquire necessary vehicle data and driver data at any desired timing by utilizing the API.

As shown in FIG. 8, the control unit 31 of the management center 3 generates the trigger information as appropriate and updates contents of the distribution information storage unit 54. the contents of the distribution information storage unit 54 may be updated based on the trigger information generated at an outside of the management center 3.

The control unit 31 executes a process as the distributor unit 51 as appropriate. Specifically, following a command from an outside, the control unit 31 distributes the trigger information stored in the distribution information storage unit 54 to the in-vehicle device 2 of the designated vehicle. The trigger information may be distributed to all vehicles.

The control unit 21 of the in-vehicle device 2 receives the trigger information distributed from the management center 3 and executes a process as the dissatisfaction survey unit 42. Specifically, the control unit 21 stores the distributed trigger information in the trigger storage unit 45 and repeatedly executes the dissatisfaction survey process to collect the dissatisfaction survey data according to the trigger information stored in the trigger storage unit 45.

Now, the dissatisfaction survey process executed by the control unit 21 will be described using the flowchart in FIG. 9. The dissatisfaction survey process is executed for each trigger information record identified by the trigger ID.

In S110, the control unit 21 acquires the determination data used for the trigger condition of the trigger information of interest. The determination data may be acquired from the vehicle DB 44 or may be acquired directly from the ECU 26 or the retrofit-device group 27 using the API.

In S120, the control unit 21 determines whether or not the trigger condition is established. If the trigger condition is established, the process proceeds to S130. If the trigger condition is not established, the process is ended.

In S130, the control unit 21 refers to the “inquiry necessity/unnecessity” contained in the trigger information and determines whether the inquiry to the driver is required to be made. Upon the control unit 21 determining that the inquiry to the driver is required to be made, the process proceeds to S140. Upon determining that the inquiry to the driver is not required to be made, the process proceeds to S170.

In S140, the control unit 21 makes the inquiry to the driver following the “inquiry content” contained in the inquiry information of the trigger information. Specifically, as shown in FIG. 8, using API or the like, an inquiry command is issued to the ECU 26 or the retrofit-device including means for the inquiry manner.

In S150, using API or the like, the control unit 21 acquires the driver response data indicated in the “user response option” contained in the trigger information from the ECU 26 or the retrofit-device having that information, as shown in FIG. 8. Part or all of the driver response data may be acquired from the vehicle DB 44. When the driver response is checked with the voice of the driver, the driver speech data is used as the driver response data. When the driver response is checked with the facial expression of the driver, the image data including the driver face driver speech data is used as the driver response data. When the driver response is checked with the gesture of the driver, the image data including the upper body of the driver is used as the driver response data. When the driver response is checked with the driver's driving operation, the vehicle data representing the vehicle operation is used as the driver response data.

In S160, the control unit 21 determines whether or not the driver dissatisfaction is indicated in the driver response data. if the driver dissatisfaction is indicated, the process proceeds to S170. If the driver dissatisfaction is not indicated, the process is ended. When the driver response data is the speech data, the determination as to the presence/absence of the dissatisfaction may be made according to a result of the speech recognition processing. When the driver response data is the image data, the determination as to the presence/absence of the dissatisfaction may be made according to a result of the image recognition processing. In the case of absence of the driver response, this may be determined to be a positive response to the inquiry; or inversely, this may be determined to be a negative response to the inquiry. Whether the absence of the driver response is determined to be the positive or negative response may be configurable by the driver.

In S170, the control unit 21 refers to the retrieval data item list of the trigger information and collects the data indicated in the retrieval data item list. The data indicated in the retrieval data item list may be acquired from the vehicle DB 44 or may be acquired directly from the ECU 26 or the retrofit-device group 27 using the API.

In S180, as the dissatisfaction survey data, the control unit 21 transmits the data collected in S170 to the management center 3 together with the driver ID and the trigger ID, and the process is ended.

The description returns to FIG. 8. When the control unit 31 of the management center 3 receives the dissatisfaction survey data from the in-vehicle device 2, the control unit 31 executes a process as the data receiver unit 53. Specifically, the control unit 31 classifies the received dissatisfaction survey data using the driver ID and the trigger ID attached to the dissatisfaction survey data and stores it in the dissatisfaction DB 56 for each classification.

The data stored in the dissatisfaction DB 56 is used to improve an application related to the situation where the trigger condition is established.

### 1-4. Correspondence of Terms

In the present embodiment, S110 corresponds to a first acquirer of the present disclosure, S120 corresponds to a first determiner of the present disclosure, S170 and S190 correspond to a second acquirer of the present disclosure, and S140 corresponds to an asker of the present disclosure. In the present embodiment, S150 corresponds to a third acquirer of the present disclosure, S160 corresponds to a second determiner of the present disclosure, the data receiver unit 53 corresponds to a collector of the present disclosure, and the management center 3 corresponds to an external device of the present disclosure. In the present embodiment, S180 corresponds to a transmitter of the present disclosure.

### 1-5. Effects

The embodiment described in detail so fart can provide the following effects.

(1a) In the data collection system 1, upon establishment of the trigger condition, the inquiry is made to the driver about whether or not the driver is dissatisfied with a situation pertaining to the establishment of the trigger condition (e.g., a processing result of an application) and the presence/absence of the driver dissatisfaction is determined from the driver response to the inquiry. Therefore, it is possible to efficiently collect the vehicle data and the driver data representing the situation where the driver feels dissatisfied.

(1b) In the data collection system 1, the driver response options include the vehicle operation of the driver, in addition to the driver speech, the driver facial expression, the driver gesture. Under various situation including where the driver is busy, it is possible to acquire the driver response data while minimizing the driver burden.

### 2. Second Embodiment

2-1. Difference from First Embodiment

Because the second embodiment is basically the same as the first embodiment in configuration, differences will be described below. The same reference symbol as in the first embodiment denote the same element, and reference is made to the preceding description.

In the first embodiment described above, the in-vehicle device 2 executes the process of making the determination as to the driver dissatisfaction based on the driver response data. The second embodiment differs from the first embodiment in that a management center 3a executes the dissatisfaction determination process. Specifically, the differences from the first embodiment include a functional configuration of the management center 3a and contents of the dissatisfaction survey process executed by the control unit 21 of an in-vehicle device 2a.

### 2-2. Functional Configuration

The functional configuration of the data collection system 1 of the second embodiment will be described below.

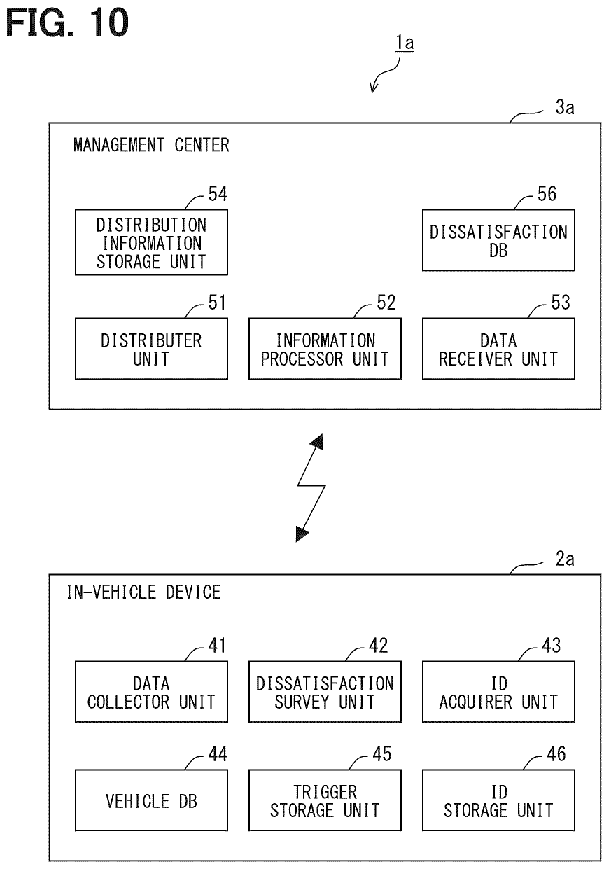

As shown in FIG. 10, the management center 3 includes an information processor unit 52 in addition to the distributor unit 51 and the data receiver unit 53 as functional blocks implemented by the CPU 311 executing the program stored in the ROM 312. Details of the information processor unit 52 will be described later.

### 2-3. Process

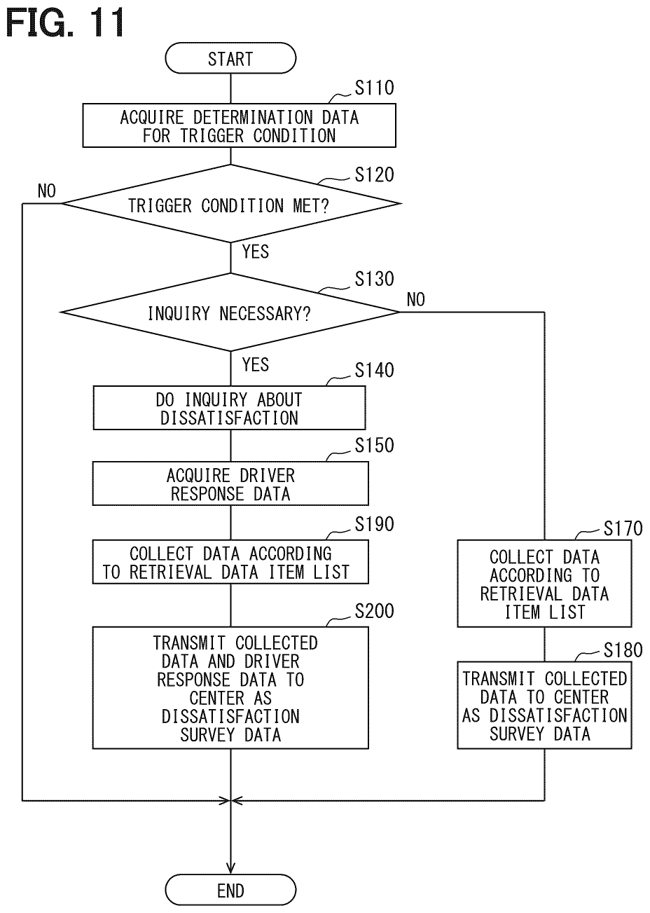

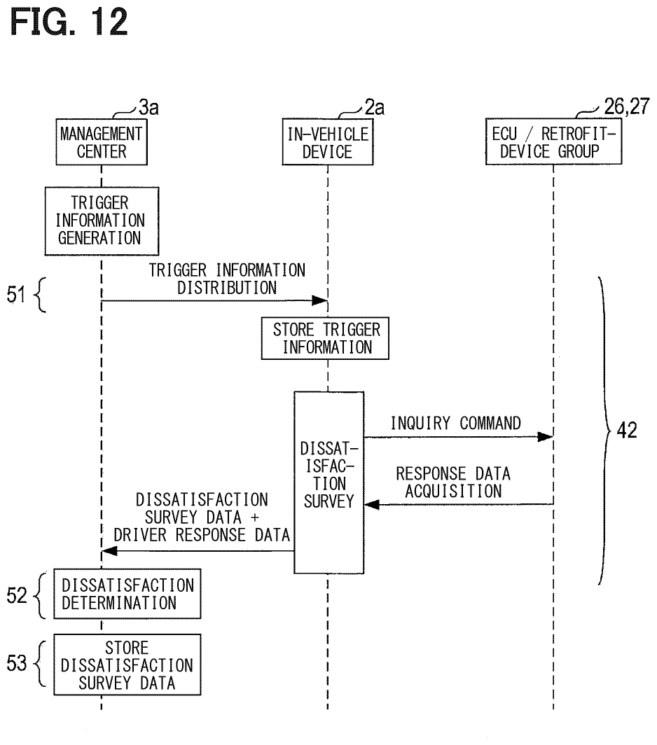

Next, the dissatisfaction survey process executed by the control unit 21 of the in-vehicle device 2a of the second embodiment in place of the dissatisfaction survey process of the first embodiment shown in FIG. 9 will be described using the flowchart of FIG. 12. The process S110 to S150, S170, S180 in FIG. 11 is the same as the process S110 to S150, S170, S180 in FIG. 9, so the description is omitted.

As shown in FIG. 11, in S150, the control unit 21 acquires the driver response data and the process proceeds to S190.

In S190, the control unit 21 refers to the retrieval data item list of the trigger information like in S170 and acquires the data indicated in the retrieval data item list. The data indicated in the retrieval data item list may be acquired from the vehicle DB 44 or may be acquired directly from the ECU 26 or the retrofit-device group 27 using the API.

In S200, as the dissatisfaction survey data, the control unit 21 transmits the data collected in S190 to the management center 3a together with the driver response data acquired in S150, the driver ID, and the trigger ID.

As shown in FIG. 12, when the control unit 31 of the management center 3a receives the driver response data together with the dissatisfaction survey data from the in-vehicle device 2a, the control unit 31 executes a process as the data processor unit 52. Specifically, the control unit 31 executes the same process as the control unit 21 of the first embodiment executes in S160. Specifically, the control unit 31 determines whether or not the driver dissatisfaction is indicated in the driver response data. Upon determining that the driver dissatisfaction is indicated, the control unit 31 executes a process as the data receiver unit 53. Specifically, the control unit 31 classifies the received dissatisfaction survey data using the driver ID and the trigger ID attached to the dissatisfaction survey data and stores it in the dissatisfaction DB 56 for each classification.

Upon determining that the driver dissatisfaction is not indicated, the control unit 31 discards the dissatisfaction survey data received together with the driver response data. Instead of discarding the dissatisfaction survey data, the dissatisfaction survey data may be stored as data in the case of dissatisfaction absence 56.

When the control unit 31 receives the dissatisfaction survey data not attached with the driver response data from the in-vehicle device 2a, the control unit 31 executes the process as the data receiver unit 53 without executing the process as the information processor unit 52.

### 2-4. Correspondence of Terms

In the present embodiment, S170, S190 correspond to a second determiner of the present disclosure, S200 corresponds to a transmitter of the present disclosure The information processor unit 52 of the management center 3a corresponds to a second acquirer and a second determiner, and the data receiver unit 53 corresponds to a third acquirer.

### 2-5. Effects

The second embodiment described above in detail provides the above-described effect (1a) of the first embodiment and further provides the following effects.

(2a) In the data collection system 1, the in-vehicle device 2a causes the management center 3a to execute processing on the driver response data which may include computationally intensive processing such as the speech recognition processing, the image recognition processing, the statistical processing, etc. Therefore, even in the case of the in-vehicle device 2a having low processing-performance, it is possible to collect the dissatisfaction survey data with high accuracy.

### 3. Other Embodiments

Although the embodiments of the present disclosure have been described above, the present disclosure is not limited to the above embodiments, and various modifications can be made.

(3a) In the above embodiment, the single management unit 3, 3a has the function of the distributor unit 51, the function of the data receiver unit 53, and the management unit 3a further the function of the information processor unit 52. Such external devices as separate servers or the like may have the respective functions.

(3b) in the second embodiment, the control unit 31 of the management center 3a is required to perform processing on the driver response data of a large number of drivers transmitted from a large number of the in-vehicle devices 2a. For the processing on the driver response data, adjustment parameters linked to the driver IDs may be prepared in advance and the control unit 31 may use the adjustment parameter to perform the processing personalized for each driver. In this case, a determination result variation due to individual differences among drivers is reducible.

(3c) Multiple functions of one element in the above embodiments may be implemented by multiple elements, or one function of one element may be implemented by multiple elements. Further, multiple functions of multiple elements may be implemented by one element, or one function implemented by multiple elements may be implemented by one element. In the above embodiments, part of the configuration may be omitted. At least part of the configuration of the above embodiment may be added to or substituted for the configuration of another embodiment.

The present disclosure can be implemented in various forms such as the in-vehicle device 2, the management center 3 and the data collection system 1, and additionally programs causing computers to function as the in-vehicle device and the management center, non-transitory tangible storage medium storing the programs such as semiconductor memories, data collection method, etc.

### Technical Ideas Disclosed in the Present Disclosure

(Item 1). A data collection system comprises:
a distributor (51) configured to distribute, to one or more vehicles, trigger information in which a trigger condition and one or more retrieval data items to be acquired upon establishment of the trigger condition are linked to each other, wherein the trigger condition is defined by one or more individual conditions in combination that a determination data is to meet, wherein the determination data is based on one or more data items acquired from the vehicle;
a first acquirer (21: S110) configured to acquire, from a target vehicle, the determination data used for the trigger condition according to the trigger information, wherein the target vehicle is the vehicle to which the trigger information is distributed;
a first determiner (21: S120) configured to determine whether or not the trigger condition is established, by using the determination data acquired by the first acquirer;
a second acquirer (21: S170, S190) configured to, upon the first determiner determining that the trigger condition is established, acquire the one or more retrieval data items linked to the trigger condition in the trigger information from the target vehicle;
an asker (21: S140) configured to, upon the first determiner determining that the trigger condition is established, make an inquiry to a driver of the target vehicle; and
a third acquirer (21: S150) configured to acquire a driver response data indicating a driver response to the inquiry made by the asker from the target vehicle.

(Item 2). In the data collection system according to Item 1:
inquiry information indicating content of the inquiry to be made to the driver upon the establishment of the trigger condition is additionally linked to the trigger condition in the trigger information distributed by the distributor until; and
the asker is configured to, upon the first determiner determining that the trigger condition is establishment, make the inquiry to the driver of the target vehicle according to the inquiry information linked to the trigger condition.

(Item 3). In the data collection system according to Item 1 or 2:
inquiry necessity or inquiry unnecessity is settable in the trigger information distributed by the distributor to indicate whether to make the inquiry to the driver of the target vehicle upon the establishment of the trigger condition; and
the asker is configured to make the inquiry to the driver of the target vehicle upon the establishment of the trigger condition for which the inquiry necessity is set in the distributed trigger information.

(Item 4). The data collection system according to any one of Items 1 to 3 further comprises:
a second determiner (21: S160,52) configured to determine whether or not driver dissatisfaction is indicated in the driver response data acquired by the third acquirer; and
a collector (53) configured to, upon the second determiner determining that driver dissatisfaction is indicated in the driver response data, collect dissatisfaction survey data by storing the one or more retrieval data items acquired by the second acquirer in a storage device as the dissatisfaction survey data.

(Item 5). The data collection system according to Item 4 further comprises:
an in-vehicle device that is mounted on the vehicle and includes the first acquirer, the first determiner, the second acquirer, the asker, the third acquirer, and the second determiner; and
an external device that performs wireless communication with the in-vehicle device and includes the distributor and the collector,
wherein:
the second acquirer is configured to acquire the one or more retrieval data items upon the second determiner determining that driver dissatisfaction is indicated in the driver response data; and
the in-vehicle device further includes:
a transmitter (21: S180) configured to transmit the one or more retrieval data items acquired by the second acquirer to the external device.

(Item 6). The data collection system according to Item 4 further comprises:
an in-vehicle device that is mounted on the vehicle and includes the first acquirer, the first determiner, the second acquirer, the asker, and the third acquirer; and
an external device that performs wireless communication with the in-vehicle device and includes the distributor, the second determiner and the collector,
wherein:
the in-vehicle device further includes:
a transmitter (21: S200) configured to transmit the one or more retrieval data items acquired by the second acquirer and the driver response data acquired by the third acquirer to the external device.

(Item 7). In the data collection system according to any one of Items 1 to 6:
the asker makes the inquiry using at least one of: speech, screen display, or vehicle behavior.

(Item 8). In the data collection system according to any one of Items 1 to 7:
the driver response data acquired by the second acquirer includes at least one of: speech data of the driver; image data of the driver's face; or a vehicle operation by the driver.

What is claimed is:

1. A data collection system for collecting a data on user satisfaction with a processing result of an application program used in a vehicle, comprising:
at least one computer including: at least one processor that executes a program; and/or at least one integrated circuit,
the at least one computer implementing:
a distributor configured to distribute, to one or more vehicles, trigger information in which a trigger condition and one or more retrieval data items to be acquired upon establishment of the trigger condition are linked to each other, wherein the trigger condition is defined by one or more individual conditions in combination that a determination data is to meet, wherein the determination data is based on one or more data items acquired from the vehicle;
a first acquirer configured to acquire, from a target vehicle, the determination data used for the trigger condition according to the trigger information, wherein the target vehicle is the vehicle to which the trigger information is distributed;
a first determiner configured to determine whether or not the trigger condition is established, by using the determination data acquired by the first acquirer;
a second acquirer configured to, upon the first determiner determining that the trigger condition is established, acquire the one or more retrieval data items linked to the trigger condition in the trigger information from the target vehicle;
an asker configured to, upon the first determiner determining that the trigger condition is established, make an inquiry to a driver of the target vehicle about a processing result of the application program; and
a third acquirer configured to acquire a driver response data indicating a driver response to the inquiry made by the asker from the target vehicle.

2. The data collection system according to claim 1, wherein:
inquiry information indicating content of the inquiry to be made to the driver upon the establishment of the trigger condition is additionally linked to the trigger condition in the trigger information distributed by the distributor until; and
the asker is configured to, upon the first determiner determining that the trigger condition is established, make the inquiry to the driver of the target vehicle according to the inquiry information linked to the trigger condition.

3. The data collection system according to claim 1, wherein:
for each trigger information, a setting value as to inquiry necessity or inquiry unnecessity is contained in the trigger information distributed by the distributor to indicate whether to make the inquiry to the driver of the target vehicle upon the establishment of the trigger condition; and
upon the establishment of the trigger condition, the asker is configured to refer to the setting value as to the inquiry necessity or the inquiry unnecessity linked to the established trigger condition and determine whether to make the inquiry to the driver of the target vehicle.

4. The data collection system according to claim 1, wherein:
the at least one computer further implements:
a second determiner configured to determine whether or not driver dissatisfaction is indicated in the driver response data acquired by the third acquirer; and
a collector configured to, upon the second determiner determining that driver dissatisfaction is indicated in the driver response data, collect dissatisfaction survey data by storing the one or more retrieval data items acquired by the second acquirer in a storage device as the dissatisfaction survey data, wherein upon the second determiner determining that driver dissatisfaction is not indicated in the driver response data, the collector does not store the one or more retrieval data items acquired by the second acquirer in the storage device as the dissatisfaction survey data.

5. The data collection system according to claim 4, wherein:
the at least one computer further implements:
an in-vehicle device that is mounted on the vehicle and includes the first acquirer, the first determiner, the second acquirer, the asker, the third acquirer, and the second determiner; and
an external device that performs wireless communication with the in-vehicle device and includes the distributor and the collector,
wherein:
the second acquirer is configured to acquire the one or more retrieval data items upon the second determiner determining that driver dissatisfaction is indicated in the driver response data; and
the in-vehicle device further includes:
a transmitter configured to transmit the one or more retrieval data items acquired by the second acquirer to the external device.

6. The data collection system according to claim 4, wherein:
the at least one computer further implements:
an in-vehicle device that is mounted on the vehicle and includes the first acquirer, the first determiner, the second acquirer, the asker, and the third acquirer; and
an external device that performs wireless communication with the in-vehicle device and includes the distributor, the second determiner and the collector,
wherein:
the in-vehicle device further includes:
a transmitter configured to transmit the one or more retrieval data items acquired by the second acquirer and the driver response data acquired by the third acquirer to the external device.

7. The data collection system according to claim 1, wherein
the asker makes the inquiry using at least one of: speech, screen display, or vehicle behavior.

8. The data collection system according to claim 1, wherein
the driver response data acquired by the second acquirer includes at least one of: speech data of the driver; image data of the driver's face; or a vehicle operation by the driver.

9. An in-vehicle device for collecting a data on user satisfaction with a processing result of an application program used in a vehicle, comprising:
at least one computer including: at least one processor that executes a program; and/or at least one integrated circuit,
the at least one computer implementing:
a trigger information storage that stores trigger information in which a trigger condition and one or more retrieval data items to be acquired upon establishment of the trigger condition are linked to each other, wherein the trigger condition is defined by one or more individual conditions in combination that a determination data is to meet, wherein the determination data is based on one or more data items acquired from a vehicle equipped with the in-vehicle device;
a first acquirer configured to acquire, from the vehicle, the determination data used for the trigger condition according to the trigger information;
a first determiner configured to determine whether or not the trigger condition is established, by using the determination data acquired by the first acquirer;
an asker configured to, upon the first determiner determining that the trigger condition is established, make an inquiry to a driver of the vehicle about a processing result of the application program;
a third acquirer configured to acquire a driver response data indicating a driver response to the inquiry made by the asker from the vehicle;
a second determiner configured to determine whether or not driver dissatisfaction is indicated in the driver response data acquired by the third acquirer;
a second acquirer configured to, upon the second determiner determining that the driver dissatisfaction is indicated in the driver response data, acquire the one or more retrieval data items linked to the trigger condition in the trigger information from the vehicle; and
a transmitter configured to transmit the one or more retrieval data items acquired by the second acquirer to an external device that performs wireless communication with the in-vehicle device.

10. An in-vehicle device for collecting a data on user satisfaction with a processing result of an application program used in a vehicle, comprising:
at least one computer including: at least one processor that executes a program; and/or at least one integrated circuit,
the at least one computer implementing:
a trigger information storage that stores trigger information in which a trigger condition and one or more retrieval data items to be acquired upon establishment of the trigger condition are linked to each other, wherein the trigger condition is defined by one or more individual conditions in combination that a determination data is to meet, wherein the determination data is based on one or more data items acquired from a vehicle equipped with the in-vehicle device;
a first acquirer configured to acquire, from the vehicle, the determination data used for the trigger condition according to the trigger information, wherein a target vehicle is the vehicle to which the trigger information is distributed;
a first determiner configured to determine whether or not the trigger condition is established, by using the determination data acquired by the first acquirer;
a second acquirer configured to, upon the first determiner determining that the trigger condition is established, acquire the one or more retrieval data items linked to the trigger condition in the trigger information from the vehicle; and
an asker configured to, upon the first determiner determining that the trigger condition is established, make an inquiry to a driver of the vehicle about a processing result of the application program;
a third acquirer configured to acquire a driver response data indicating a driver response to the inquiry made by the asker from the vehicle; and
a transmitter configured to transmit the one or more retrieval data items acquired by the second acquirer and the driver response data acquired by the third acquirer to an external device that performs wireless communication with the in-vehicle device.

11. A vehicle data collection method for collecting a data on user satisfaction with a processing result of an application program used in a vehicle, comprising:
using trigger information in which a trigger condition and one or more retrieval data items to be acquired upon establishment of the trigger condition are linked to each other, wherein the trigger condition is defined by one or more individual conditions in combination that a determination data is to meet, wherein the determination data is based on one or more data items acquired from a vehicle;
acquiring, from a target vehicle, the determination data used for the trigger condition according to the trigger information, wherein the target vehicle is the vehicle to which the trigger information is distributed;
determining whether or not the trigger condition is established, by using the determination data;
upon determining that the trigger condition is established, acquiring the one or more retrieval data items linked to the trigger condition in the trigger information from the vehicle; and
upon determining that the trigger condition is established, making an inquiry to a driver of the target vehicle about a processing result of the application program;
acquiring a driver response data indicating a driver response to the inquiry from the target vehicle;
determining whether or not driver dissatisfaction is indicated in the driver response data;
upon determining that the driver dissatisfaction is indicated in the driver response data, storing the one or more retrieval data items in a storage device as dissatisfaction survey data, thereby collecting the dissatisfaction survey data.

12. A program stored in a non-transitory storage medium,
for collecting a data on user satisfaction with a processing result of an application program used in a vehicle, the program causing a computer mounted on a vehicle to use:
trigger information in which a trigger condition and one or more retrieval data items to be acquired upon establishment of the trigger condition are linked to each other, wherein the trigger condition is defined by one or more individual conditions in combination that a determination data is to meet, wherein the determination data is based on one or more data items acquired from the vehicle,
the program causing the computer to function as:
a first acquirer configured to acquire, from the vehicle, the determination data used for the trigger condition according to the trigger information;
a first determiner configured to determine whether or not the trigger condition is established, by using the determination data acquired by the first acquirer;
an asker configured to, upon the first determiner determining that the trigger condition is established, make an inquiry to a driver of the vehicle about a processing result of the application program;
a third acquirer configured to acquire a driver response data indicating a driver response to the inquiry made by the asker from the vehicle;
a second determiner configured to determine whether or not driver dissatisfaction is indicated in the driver response data acquired by the third acquirer;
a second acquirer configured to, upon the second determiner determining that the driver dissatisfaction is indicated in the driver response data, acquire the one or more retrieval data items linked to the trigger condition in the trigger information from the vehicle; and
a transmitter configured to transmit the one or more retrieval data items acquired by the second acquirer to an external device that performs wireless communication with an in-vehicle device.

13. A program stored in a non-transitory storage medium,
for collecting a data on user satisfaction with a processing result of an application program used in a vehicle, the program causing a computer mounted on a vehicle to use:
trigger information in which a trigger condition and one or more retrieval data items to be acquired upon establishment of the trigger condition are linked to each other, wherein the trigger condition is defined by one or more individual conditions in combination that a determination data is to meet, wherein the determination data is based on one or more data items acquired from the vehicle,
the program causing the computer to function as:
a first acquirer configured to acquire, from the vehicle, the determination data used for the trigger condition according to the trigger information;
a first determiner configured to determine whether or not the trigger condition is established, by using the determination data acquired by the first acquirer;
a second acquirer configured to, upon the first determiner determining that the trigger condition is established, acquire the one or more retrieval data items linked to the trigger condition in the trigger information from the vehicle; and
an asker configured to, upon the first determiner determining that the trigger condition is established, make an inquiry to a driver of the vehicle about a processing result of the application program;
a third acquirer configured to acquire a driver response data indicating a driver response to the inquiry made by the asker from the vehicle; and
a transmitter configured to transmit the one or more retrieval data items acquired by the second acquirer and the driver response data acquired by the third acquirer to an external device that performs wireless communication with the in-vehicle device.

14. A management center for collecting a data on user satisfaction with a processing result of an application program used in a vehicle, comprising:
at least one computer including: at least one processor that executes a program; and/or at least one integrated circuit,
the at least one computer implementing:
a distributor configured to distribute, to one or more vehicles, trigger information in which a trigger condition and one or more retrieval data items to be acquired upon establishment of the trigger condition are linked to each other, wherein the trigger condition is defined by one or more individual conditions in combination that a determination data is to meet, wherein the determination data is based on one or more data items acquired from the vehicle;
a second acquirer configured to acquire the one or more retrieval data items linked to the trigger condition in the trigger information from a target vehicle upon a first determiner determining that the trigger condition is established, wherein the first determiner is configured to determine whether or not the trigger condition is established by using the determination data used for the trigger condition according to the trigger information, wherein the target vehicle is the vehicle to which the trigger information is distributed; and
a third acquirer configured to acquire a driver response data indicating a driver response to an inquiry made by an asker from the target vehicle, wherein the asker is configured to, upon the first determiner determining that the trigger condition is established, make the inquiry to a driver of the target vehicle about a processing result of the application program.

15. A data collection method for collecting a data on user satisfaction with a processing result of an application program used in a vehicle, comprising:
distributing, to one or more vehicles, trigger information in which a trigger condition and one or more retrieval data items to be acquired upon establishment of the trigger condition are linked to each other, wherein the trigger condition is defined by one or more individual conditions in combination that a determination data is to meet, wherein the determination data is based on one or more data items acquired from the vehicle;
acquiring the one or more retrieval data items linked to the trigger condition in the trigger information from a target vehicle upon a first determiner determining that the trigger condition is established, wherein the first determiner is configured to determine whether or not the trigger condition is established by using the determination data used for the trigger condition according to the trigger information, wherein the target vehicle is the vehicle to which the trigger information is distributed; and
acquiring a driver response data indicating a driver response to an inquiry made by an asker from the target vehicle, wherein the asker is configured to, upon the first determiner determining that the trigger condition is established, make the inquiry to a driver of the target vehicle about a processing result of the application program.

16. A program stored in a non-transitory storage medium,
for collecting a data on user satisfaction with a processing result of an application program used in a vehicle, the program causing a computer of a management center to function as:
a distributor configured to distribute, to one or more vehicles, trigger information in which a trigger condition and one or more retrieval data items to be acquired upon establishment of the trigger condition are linked to each other, wherein the trigger condition is defined by one or more individual conditions in combination that a determination data is to meet, wherein the determination data is based on one or more data items acquired from the vehicle;
a second acquirer configured to acquire the one or more retrieval data items linked to the trigger condition in the trigger information from a target vehicle upon a first determiner determining that the trigger condition is established, wherein the first determiner is configured to determine whether or not the trigger condition is established by using the determination data used for the trigger condition according to the trigger information, wherein the target vehicle is the vehicle to which the trigger information is distributed; and
a third acquirer configured to acquire a driver response data indicating a driver response to an inquiry made by an asker from the target vehicle, wherein the asker is configured to, upon the first determiner determining that the trigger condition is established, make the inquiry to the driver of the target vehicle about a processing result of the application program.
